(19) United States
(12) Patent Application Publication
(10) Pub. No.: US 2005/0132061 A1
(43) Pub. Date: Jun. 16, 2005

(54) Method for autoconfiguring CPEs in DSL networks

(75) Inventors: Yves Robert Fernand T'Joens, Sint Michiels-Brugge (BE); Jeremy Nicolas Jean Herman De Clercq, Gent (BE)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/999,991

(22) Filed: Dec. 1, 2004

(30) Foreign Application Priority Data
Dec. 12, 2003 (EP) 03293150.3

(51) Int. Cl. G06F 15/16

(52) U.S. Cl. 709/227

(57) ABSTRACT

Method for auto-configuration of Customer Premises Equipment (CPE) in a digital subscriber line access aggregation network, where the CPE establishes a Label Switched Path to a Broadband Remote Access Server (BRAS) and obtains configuration data via IP protocol.

### FIELD OF THE INVENTION

The present invention relates to a method for autoconfiguring Customer Premises Equipment (CPE) devices in DSL aggregation networks.

### BACKGROUND OF THE INVENTION

Digital Subscriber Line Access Aggregation networks are currently usually based on Asynchronous Transfer Mode (ATM). The Customer Premises equipment device establishes a layer 2/2.5 connection to an aggregation device such as a Broadband Remote Access Server (BRAS) or to an Internet Service Provider (ISP). A DSL Customer Premises Equipment device can be autoconfigured with an ATM permanent virtual connection for example via Interim Local Management Interface (ILMI) that uses Simple Network Management Protocol (SNMP).

Devices and methods known in prior art can only be used in ATM networks for autoconfiguration of Customer Premises Equipment devices. The protocols used by prior art solutions are complicated and not widely used yet. The use of permanent virtual connections in prior art solutions is not very flexible.

### OBJECTS OF THE INVENTION

The object of the invention is to disclose a method for autoconfiguration of CPE devices is usable in access aggregation networks that do not make use of ATM.

### SUMMARY OF THE INVENTION

The object of the invention is achieved by a method for auto-configuration of Customer Premises Equipment (CPE) devices in a digital subscriber line access aggregation network, where the CPE obtains configuration data via IP protocols and establishes a Label Switched Path (LSP) to a Broadband Remote Access Server (BRAS) according to claim 1. In the context of the present invention “IP-protocols” is used to denote an IP protocol suite comprising protocols like DHCP, DNS, HTTP, etc. These protocols are used for auto-configuration of the Customer Premises Equipment.

In a preferred embodiment, DHCP or DNS is used as IP auto-configuration protocol. IP auto-configuration protocols such as DHCP or DNS are very widely used in other contexts. DHCP is used to configure layer 3 information of customers in local area networks and DNS is used to configure some layer 3 information of customers in Internet Service Provider Networks. The mechanisms proposed have the additional advantage that they still can be used whenever other technologies than ATM, for example Ethernet, will be used in Access aggregation networks.

Preferably a layer 2 connection is established between a Digital Subscriber Line (DSL) Customer Premises Equipment (CPE) and an Internet Service Provider (ISP) Broadband Remote Access Server (BRAS) via said access-aggregation network.

The Method preferably comprises the steps of: sending a Dynamic Host Control Protocol request (DHCP-request) to the access network by said Customer Premises Equipment (CPE); relaying said DCHP-request to a DHCP-server that serves the access network; receiving a DHCP-reply, that reply containing an IP-address for using IP-signaling in the access network context and an access-server IP-address or an access-server name; and establishing a Labled Switched Path (LSP) connection between that Broadband Remote Access Server (BRAS) and said Customer Premises Equipment (CPE) by said Customer Premises Equipment (CPE). A control Virtual Connection (cVC) might be used to send the DHCP-request to the access network if ATM is used in the access network. Said Customer Premises Equipment (CPE) might querie a domain name service (DNS) dedicated to said access aggregation network for an IP-address if said DHCP-message contains an access-server name and subsequently receives an IP-address of said Broadband Remote Access Server (BRAS) between said steps of receiving a DHCP-reply and establishing a Labled Switched Path (LSP). This query is usable only in the access network control plane.

The object of the invention is also achieved by a Digital Subscriber Line Access Multiplexer (DSLAM) for use in a method according to the present invention and a Customer Premises Equipment (CPE) for use in a method according to the present invention.

### BRIEF DESCRIPTION OF THE DRAWINGS

In the following description of a preferred embodiment of the present invention, it is referred to the accompanying drawing wherein:

FIG. 1 depicts a sketch of an ADSL aggregation access network topology.

### DETAILED DESCRIPTION OF THE INVENTION

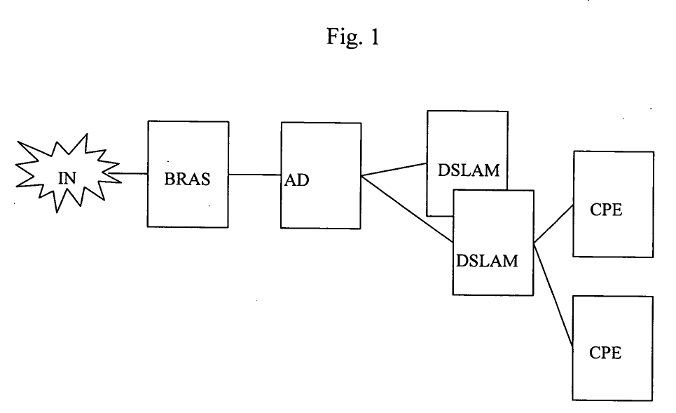

FIG. 1 shows a typical residential Asymetric Digital Subscriber Line (ADSL) deployment for internet access. The ADSL links from multiple Customer Premises Equipments (CPE) are terminated by a Digital Subscriber Line Access Multiplexer (DSLAM). The traffic of a number of DSLAMs is forwarded to an aggregation device, typically an ATM-switch AD. The switch AD forwards the aggregated traffic to a Broadband Remote Access Server (BRAS). The BRAS performs format conversion, subscriber identification and other functions before forwarding Internet Protocol (IP) traffic to and receiving it from the internet IN.

The connection between DSLAM, AD and BRAS is usually established by an ATM network. Instead of pure ATM, Multi Protocol Lable Switching (MPLS) is used here. When MPLS is used in the Broadband Aggregation Access Network, virtual connections (VC) that connect CPE to a BRAS can be signaled via the MPLS control plane. These virtual connections can still be ATM virtual connections or alternatively MPLS Labled Switched Paths (LSP). For this to be possible the access network needs to be configured as an IP-network at the control plane level of MPLS. New CPE devices can then be autoconfigured in the access network using IP autoconfiguration protocols which are normally used for other purposes and other contexts, such as DHCP and DNS. The received configuration information is only used to establish a layer 2/2.5 connection, that is a Labled Switched Path in Multi Protocol Lable Switching, to the Broadband Remote Access Server (BRAS). The configuration information will not be used in the later exchanged IP data packets. Such pure privat adress can be used in the access network without any need for IP adress translation. The established Labled Switched Path is seen as a layer 2 connection and the IP configuration information will not be used any more. The IP configuration information needed for the layer 3 IP data plane will be received via traditional means for example via PPP or DHCP from an ISP over the established Multi Protocol Lable Switching—Labled Switched Path.

1. Method for auto-configuration of Customer Premises Equipment (CPE) devices in a digital subscriber line access aggregation network, characterized in that the CPE obtains configuration data via IP protocols and establishes a Label Switched Path (LSP) to a Broadband Remote Access Server (BRAS).

2. Method according to claim 1, characterized in that DHCP or DNS is used as IP auto-configuration protocol.

3. Method according to claim 1, characterised in that a layer 2 connection is established between a Digital Subscriber Line (DSL) Customer Premises Equipment (CPE) and an Internet Service Provider (ISP) Broadband Remote Access Server (BRAS) via said access-aggregation network.

4. Method according to claim 1 characterised in that said method comprises the steps of:
4.1 Sending a Dynamic Host Control Protocol request (DHCP-request) to the access network by said Customer Premises Equipment (CPE);
4.2 relaying said DCHP-request to a DHCP-server that serves the access network;
4.3 receiving a DHCP-reply, that reply containing an IP-address for using signalling in the access network context and an access-server IP-address or an access-server name; and
4.4 establishing a Labled Switched Path (LSP) connection between that Broadband Remote Access Server (BRAS) and said Customer Premises Equipment (CPE) by said Customer Premises Equipment (CPE).

5. Method according to claim 1, characterised in that said Customer Premises Equipment (CPE) queries a domain name service (DNS) dedicated to said access aggregation network for an IP-address if said DHCP-message contains an access-server name and subsequently receives an IP-address (usable only in the access network control plane) of said Broadband Remote Access Server (BRAS) between said steps 4.3 and 4.4.

6. Digital Subscriber Line Access Multiplexer (DSLAM) for use in a method according to claim 1.

7. Customer Premises Equipment (CPE) for use in a method according to claim 1.
